(19) United States
(12) Patent Application Publication
(10) Pub. No.: US 2017/0059975 A1
(43) Pub. Date: Mar. 2, 2017

(54) OPTICAL APPARATUS AND PROJECTION APPARATUS

(71) Applicant: JVC KENWOOD Corporation, Yokohama-shi (JP)

(72) Inventor: Takatsugu Aizaki, Yokohama-shi (JP)

(21) Appl. No.: 15/219,535

(22) Filed: Jul. 26, 2016

(30) Foreign Application Priority Data
Aug. 26, 2015 (JP) 2015-166954

(51) Int. Cl. G03B 21/20; G02B 26/00; G02B 27/28; G03B 21/00

(52) U.S. Cl. CPC G03B 21/204; G03B 21/2073; G03B 21/005; G02B 26/008; G02B 27/283

(57) ABSTRACT

An optical apparatus according to an embodiment of the present invention includes a reflective substrate which reflects irradiating light, and a driving unit which rotates the reflective substrate centering on a rotating axis. Furthermore, the optical apparatus divides the reflective substrate into first and second regions in a circumferential direction centering on the rotating axis. A phosphor is provided upon the first region, one of first and second regions dividing the reflective substrate. The phosphor is stimulated by the irradiating light and radiates light whose color is different from the irradiating light.

### CROSS-REFERENCE TO RELATED APPLICATION(S)

The present application claims priority to and incorporates by reference the entire contents of Japanese Patent Application No. 2015-166954 filed in Japan on Aug. 26, 2015.

### BACKGROUND OF THE INVENTION

1. Field of Invention

The present invention relates to an optical apparatus and a projection apparatus.

2. Description of the Related Art

With regard to a projection apparatus using a laser optical source as an optical source, the following projection apparatus has been developed. That is, a projection apparatus using, as optical sources, a blue laser optical source which emits a blue laser beam and a yellow phosphor which is stimulated by the blue laser beam and radiates yellow light. In such a projection apparatus, blue light emitted from the blue laser optical source and the yellow light radiated from the yellow phosphor are combined to be used as a white optical source (for example, Japanese Laid-open Patent Publication No. JP 2012-003923 A).

With regard to a blue laser beam, not the whole luminous flux irradiating a yellow phosphor is used for stimulating the yellow phosphor, but a part of the luminous flux irradiating the yellow phosphor is emitted as leakage light instead of being used for stimulating the yellow phosphor. In a case of using this blue leakage light as a blue optical source to be combined with yellow light, difficulty in improving efficiency of the blue color has been a problem in the related art.

### SUMMARY OF THE INVENTION

It is an object of the present invention to at least partially solve the problems in the conventional technology.

According to one aspect, there is provided an optical apparatus comprising: a reflective substrate which reflects irradiating light; a driving unit which rotates the reflective substrate centering on a rotating axis; and a phosphor provided to a first region, which is one of first and second regions dividing the reflective substrate in a circumferential direction centering on the rotating axis.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary configuration of a projection apparatus applicable to an embodiment of the present invention;

FIGS. 2A and 2B are graphs explaining exemplary characteristics of a dichroic mirror applicable to the embodiment of the present invention;

FIG. 3 is a view illustrating an exemplary configuration of a phosphor wheel of the related art;

FIG. 4 is a schematic view schematically illustrating diffusion of each beam on a phosphor surface in a case where the phosphor wheel of the related art is irradiated by a blue laser beam;

FIGS. 5A and 5B are views illustrating exemplary configurations of a phosphor wheel according to the embodiment of the present invention;

FIGS. 6A and 6B are a diagram and a table explaining an optical path of an optical apparatus according to the embodiment of the present invention; and

FIGS. 7A and 7B are views illustrating the phosphor wheel according to the embodiment of the present invention in more detail.

### DETAILED DESCRIPTION OF THE PREFERRED EMBODIMENT

A preferred embodiment of an optical apparatus and a projection apparatus will now be described in detail with reference to the accompanying drawings. Specific numerical values and exterior configurations illustrated in the embodiment are presented for illustration purpose in order to understand the present invention easily and should not be interpreted in any restrictive way, unless otherwise specified. It should be noted that explanations and drawings of elements which are not directly related to the present invention will be omitted.

An optical apparatus according to the embodiment of the present invention uses a blue laser beam as an optical source. The blue laser beam irradiates a phosphor wheel where a phosphor is formed on a concentricity of a mirror-like surface thereof. The phosphor radiates yellow light as being stimulated by light having a wavelength band of blue light. Herein, the phosphor wheel is formed in a first region, one of first and second regions where the phosphor divides the phosphor wheel in a circumferential direction. According to the phosphor wheel configured in such a way, as the blue laser beam irradiating the first region, the yellow light and the blue light which is not used for stimulating the phosphor are both emitted from the phosphor wheel. Furthermore, irradiated by the blue laser beam, the second region reflects off and emits the blue laser beam. Therefore, by using the optical apparatus of the embodiment, it is possible to improve efficiency of emitting the blue light.

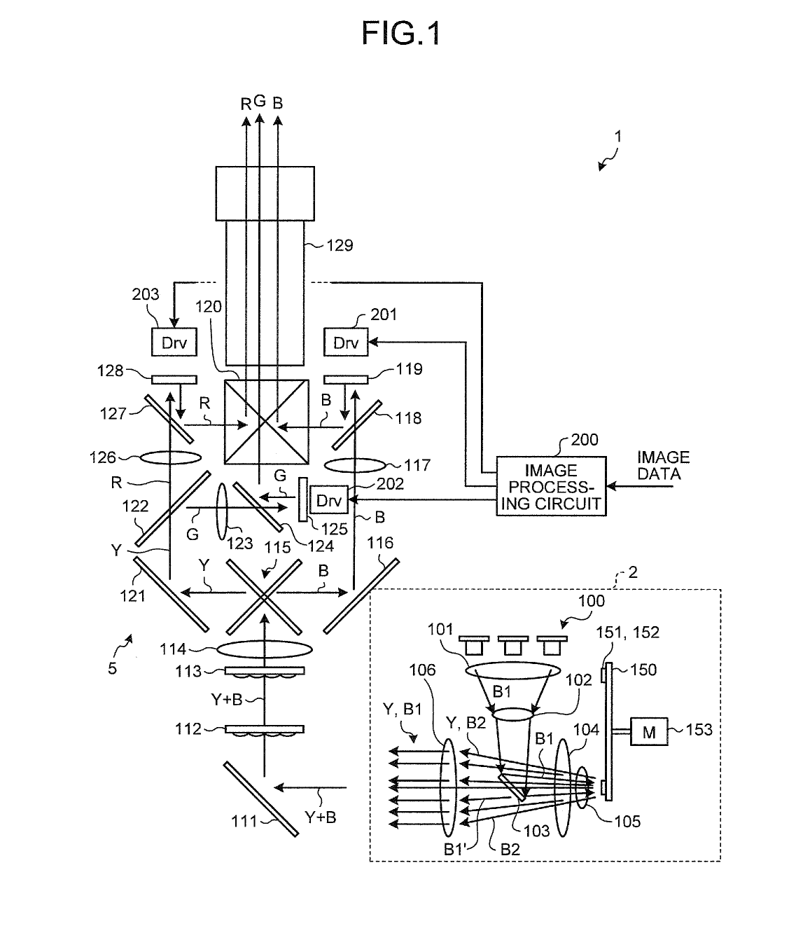

FIG. 1 illustrates an exemplary configuration of a projection apparatus applicable to the embodiment. In FIG. 1, a projection apparatus 1 includes an optical apparatus 2 according to the embodiment, an illumination optical system 5, and a projection optical unit 129. The projection apparatus 1 further includes an image processing circuit 200, optical modulators 119, 125, and 128 for each color, R (red), G (green), and B (blue), and driving circuits 201, 202, and 203 which drive the optical modulators 119, 125, and 128 respectively corresponding to an output of the image processing circuit 200.

The optical apparatus 2 includes a phosphor wheel 150, a dichroic mirror 103, and a plurality of lenses. FIG. 1 illustrates that an optical source 100 is included in the optical apparatus 2. However, the optical source 100 should not be restricted to this example and may be included in an exterior configuration of the optical apparatus 2. The optical source 100 is an optical source which emits the blue laser beam. The optical source 100 is an element aggregating a plurality of laser devices, for example, a laser diode array. The phosphor wheel 150 includes phosphor surfaces 151 and quarter-wave plates 152, and is rotated by a motor (M) 153 centering on a rotating axis (not illustrated). The phosphor surfaces 151 are formed by the phosphor which radiates the yellow light as being stimulated by the blue laser beam.

By using the blue laser beam emitted from the optical source 100 as well as the phosphor wheel 150 and the dichroic mirror 103, the optical apparatus 2 forms the blue light (referred to as B-light for convenience' sake) and the yellow light (referred to as Y-light for convenience' sake) and emits those light. The B-light and Y-light emitted from the optical apparatus 2 enter a mirror 111. Details of the optical apparatus 2 will be described later.

The B-light and Y-light emitted from the optical apparatus 2 are reflected off the mirror 111 and directions of those light are changed. The Y-light and B-light emitted from the mirror 111 enter a light separator 115 through fly eye lenses 112, 113, and a lens 114. The light separator separates the B-light from the Y-light. The B-light separated by the light separator 115 is emitted from the light separator 115 and enters a mirror 116. Furthermore, the Y-light separated by the light separator 115 is emitted from the light separator 115 and enters a mirror 121.

The B-light incident upon the mirror 116 enters a reflective polarizing plate 118 through a lens 117. The B-light transmitted through the reflective polarizing plate 118 enters the optical modulator 119. The optical modulator 119 is driven by the driving circuit 201 in accordance with a B-colored image signal which is output from the image processing circuit 200. The optical modulator 119 modulates and reflects the incident light per pixel and emits the modulated light. The B-light modulated per pixel by the optical modulator 119 in accordance with the B-colored image signal is reflected off the reflective polarizing plate 118 and is emitted with its direction being changed. Then, the B-light enters a photosynthesis prism 120 from a first surface thereof.

The Y-light separated by the light separator 115 and incident upon the mirror 121 is reflected off the mirror 121 with its direction being changed, and is emitted from the mirror 121. The Y-light emitted from the mirror 121 enters a color component separator 122. Herein, a green light component and a red light component are separated from the Y-light. For example, the color component separator 122 is configured to include a dichroic mirror which reflects light having a wavelength band of green light, and transmits light having a wavelength band of red light.

The G-light separated from the Y-light by the color component separator 122 enters a reflective polarizing plate 124 through a lens 123. The G-light is transmitted through the reflective polarizing plate 124 and enters the optical modulator 125. The optical modulator 125 is driven by the driving circuit 202 in accordance with a G-colored image signal which is output from the image processing circuit 200. The optical modulator 125 modulates and reflects the incident G-light per pixel and emits the modulated light. The G-light emitted from the optical modulator 125 is reflected off the reflective polarizing plate 124 and enters the photosynthesis prism 120 from a second surface thereof.

The R-light separated from the Y-light by the color component separator 122 enters a reflective polarizing plate 127 through a lens 126. The R-light is transmitted through the reflective polarizing plate 127 and enters the optical modulator 128. The optical modulator 128 is driven by the driving circuit 203 in accordance with an R-colored image signal which is output from the image processing circuit 200. The optical modulator 128 modulates and reflects the incident R-light per pixel and emits the modulated light. The R-light emitted from a fourth surface of the optical modulator 128 is reflected off the reflective polarizing plate 127 and enters the photosynthesis prism 120 from a third surface thereof.

The photosynthesis prism 120 synthesizes the B-light, G-light, and R-light entered from the first surface, second surface, and third surface respectively. The synthesized light is emitted, as one collective luminous flux, from a fourth surface of the photosynthesis prism 120. The luminous flux including the R-light, G-light, and B-light emitted from the photosynthesis prism 120 is emitted exteriorly through the projection optical unit 129.

Next, the optical apparatus 2 according to the embodiment will be described in further detail. In the optical apparatus 2, the optical source 100 emits an S-polarized blue laser beam (hereinafter referred to as B1-light). The B1-light emitted from the optical source 100 enters the dichroic mirror 103 through a condenser 101 and collimator lens 102. The dichroic mirror 103 transmits a P-polarized light among light having a wavelength band of the B-light, and reflects the S-polarized light. Furthermore, the dichroic mirror 103 has a characteristic of transmitting light having a wavelength band longer than the wavelength band of the B-light (for example, red light or green light).

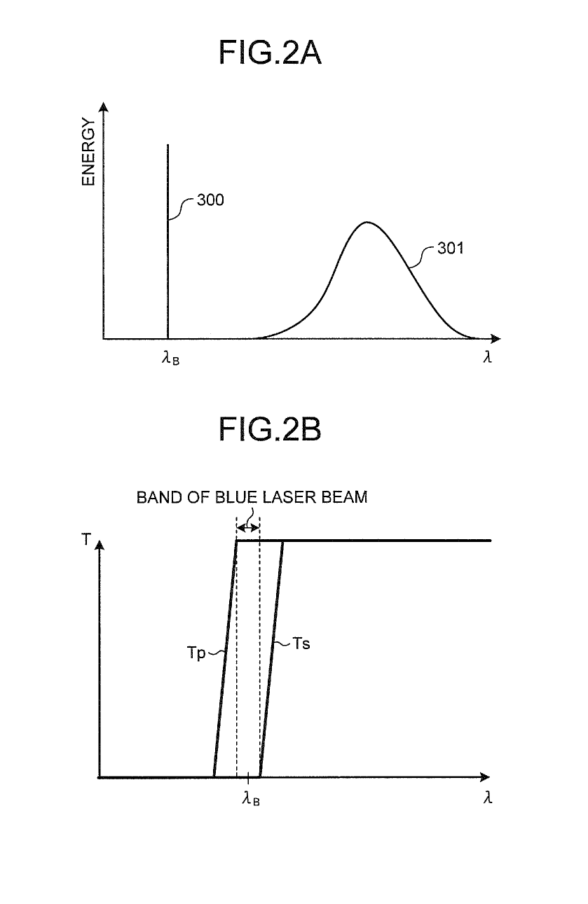

With reference to FIGS. 2A and 2B, exemplary characteristics of the dichroic mirror 103 applicable to the embodiment will be described. FIG. 2A illustrates an example of energy distribution of the blue laser beam and fluorescence (yellow light) with respect to a wavelength λ. In FIG. 2A, the wavelength λ is taken along the abscissa, and the wavelength becomes longer as facing rightward. Furthermore, the energy is taken along the ordinate. With regard to the blue laser beam, the energy converges on the wavelength λ_{B} as illustrated in a characteristic line 300. On the other hand, with regard to the fluorescence of the yellow light, the energy is distributed through a wavelength band spreading toward a wavelength side longer than the wavelength λ_{B} as illustrated in a characteristic line 301.

FIG. 2B illustrates an exemplary characteristic of the dichroic mirror 103 applicable to the embodiment. A part of the abscissa illustrated in FIG. 2A is enlarged and taken along the abscissa in FIG. 2B. The wavelength herein becomes longer as facing rightward. Transmissivity T is taken along the ordinate. As facing upward, the transmissivity becomes higher and the reflectivity becomes lower. When the transmissivity T is maximum, the reflectivity is minimum (for example, substantially zero). When the transmissivity T is minimum, the reflectivity is maximum (for example, substantially total reflection). The blue laser beam has a wavelength band with a predetermined width centering on the wavelength λ_{B}.

With regard to the dichroic mirror, it is known that the S-polarized light and the P-polarized light have different characteristics. In FIG. 2B, the dichroic mirror 103 has a characteristic that the transmissivity T is minimum, while the reflectivity is maximum with respect to the S-polarized blue laser beam as illustrated in characteristic line Ts. Furthermore, with respect to the P-polarized blue laser beam, the transmissivity T is maximum, while the reflectivity is minimum as illustrated in characteristic line Tp. Furthermore, with regard to the fluorescence of the yellow light, a wavelength thereof in a short wavelength side of the wavelength band is longer than the wavelength λ_{B}. Herein, the transmissivity T is maximum, while the reflectivity is minimum within the whole wavelength band. In such a manner, the dichroic mirror 103 performs as a light selecting unit which selectively transmits or reflects light under a specific condition.

The S-polarized B-light emitted from the optical source 100 and incident upon the dichroic mirror 103 is reflected off the dichroic mirror 103 and enters, through condensers 104 and 105, the phosphor wheel 150 rotatably driven by the motor (M) 153.

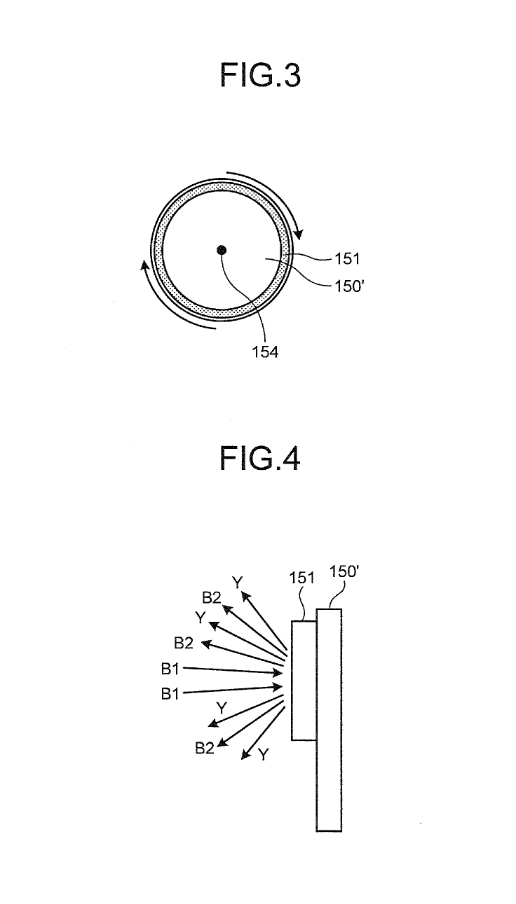

FIG. 3 is an exemplary configuration of a phosphor wheel 150′ of the related art. The phosphor wheel 150′ is rotated centering on a rotating axis 154 with the phosphor surface 151 formed on a mirror-like surface thereof in a concentric shape. A phosphor which is stimulated by light having a wavelength band of B-light and which radiates yellow light (referred to as Y-light for convenience' sake) is applied to the phosphor surface 151. In an additive color process, yellow is obtained by combining red and green. Therefore, the yellow light radiated by the phosphor surface 151 contains a red component and a green component.

FIG. 4 is a schematic view illustrating diffusion of each beam upon the phosphor surface 151 in a case where the phosphor wheel 150′ of the related art is irradiated by a blue laser beam (B1-light). When the phosphor surface 151 is irradiated by the B1-light, the phosphor is stimulated by the B1-light and radiates the Y-light. Furthermore, instead of contributing to stimulating the phosphor, a part of the B1-light irradiating the phosphor surface 151 is transmitted through the phosphor surface 151 and reaches the mirror surface of the phosphor wheel 150′ and is reflected off the mirror surface. A part of the B1-light reflected off the mirror surface stimulates the phosphor when passing through the phosphor surface 151 again, and then radiates the Y-light. Rest of the B1-light is emitted from the phosphor surface 151 as a B2-light instead of contributing to stimulating the phosphor.

These Y-light and B2-light emitted from the phosphor surface 151 are emitted from the phosphor surface 151 as being diffused upon a phosphor layer of the phosphor surface 151 as illustrated in FIG. 4. Furthermore, with regard to the B2-light emitted from the phosphor surface 151, a polarization direction falls into disorder with respect to the incident B1-light due to the diffusion upon the phosphor layer. Therefore, it is difficult to use this B2-light as an optical source of the blue light with high efficiency.

The following example will be taken into consideration. That is, B2-light which is to be emitted from the phosphor surface 151 as being substantially parallel to the B1-light which enters the phosphor surface 151. The B2-light enters the dichroic mirror 103. In this case, the polarization direction of the B2-light is not controlled. Therefore, a part of the B2-light incident upon the dichroic mirror 103 is reflected off the dichroic mirror 103 and is sent back to a direction of the optical source 100, and the rest of the B2-light is transmitted through the dichroic mirror 103. The B2-light sent back to the direction of the optical source 100 is not included in the B-light of the illumination optical system 5 and is wasted.

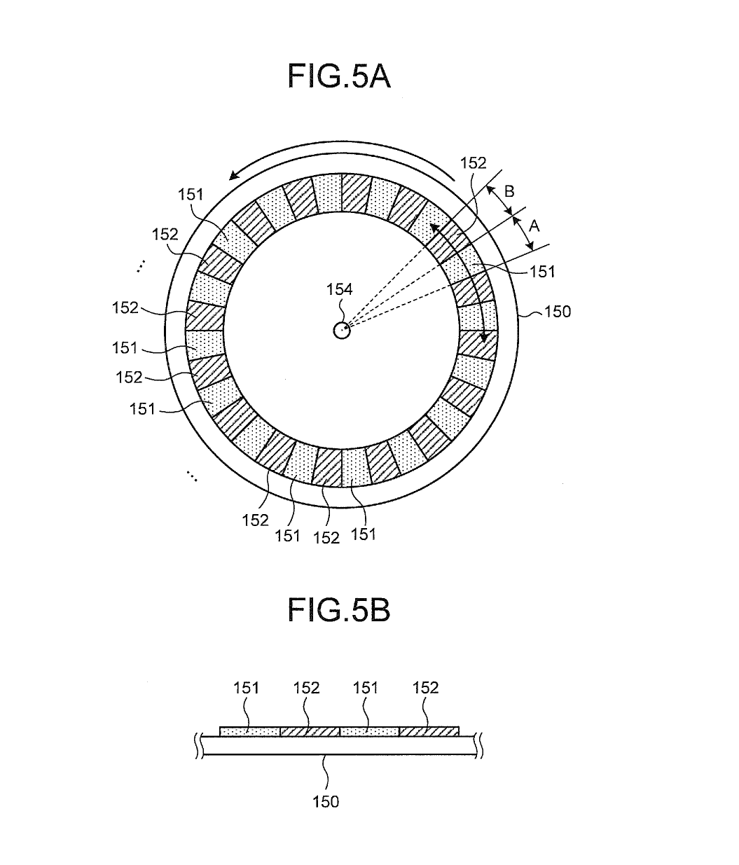

FIGS. 5A and 5B illustrate exemplary configurations of the phosphor wheel 150 according to the embodiment. In FIGS. 5A and 5B, elements common to aforementioned elements in FIG. 1 will be denoted with the same reference numeral and detailed explanations thereof will be omitted. Furthermore, the phosphor wheel 150, for example, is configured to be rotated around to the left (counterclockwise) centering on the rotating axis 154 as illustrated in FIG. 5A with a one-way arrow.

In FIG. 5A, the phosphor wheel 150 is divided into regions A (first regions) and regions B (second regions) in the circumferential direction centering on the rotating axis 154. The phosphor wheel 150 is configured to form the phosphor surfaces 151 in the regions A and to provide the quarter-wave plates 152 to the regions B. Furthermore, the phosphor wheel 150 is divided as alternatively repeating the regions A and the regions B in the circumferential direction. The phosphor surfaces 151 and the quarter-wave plates 152 are formed on a common concentricity.

Herein, the B1-light reflected off the dichroic mirror 103 enters the phosphor wheel 150 as setting a specific position of the phosphor wheel 150 as an incident position. Each quarter-wave plate 152 is provided so that a direction angle of an optical axis is set to be predetermined angle (for example, 45 degrees) with respect to a polarization plane of the incident light, when the phosphor wheel 150 is rotated and each quarter-wave plate 152 reaches the incident position.

FIG. 5B illustrates an exemplary cross-sectional view along the circumferential direction of the phosphor wheel 150. In such a manner, the phosphor surfaces 151 and the quarter-wave plates 152 both adhere closely to the surface of the phosphor wheel 150. Accordingly, the B1-light incident upon the phosphor surfaces 151 stimulates the phosphor. Furthermore, the B1-light which does not contribute to stimulating the phosphor during incidence is reflected off the mirror surface of the phosphor wheel 150 and enters the phosphor surfaces 151 again. Furthermore, the B1-light incident upon the quarter-wave plates 152 passes through the quarter-wave plates 152 and is reflected off the mirror surface of the phosphor wheel 150 and enters the quarter-wave plates 152 again. In other words, the B1-light incident upon the quarter-wave plates 152 passes through the quarter-wave plates 152 twice and is emitted from the quarter-wave plates 152.

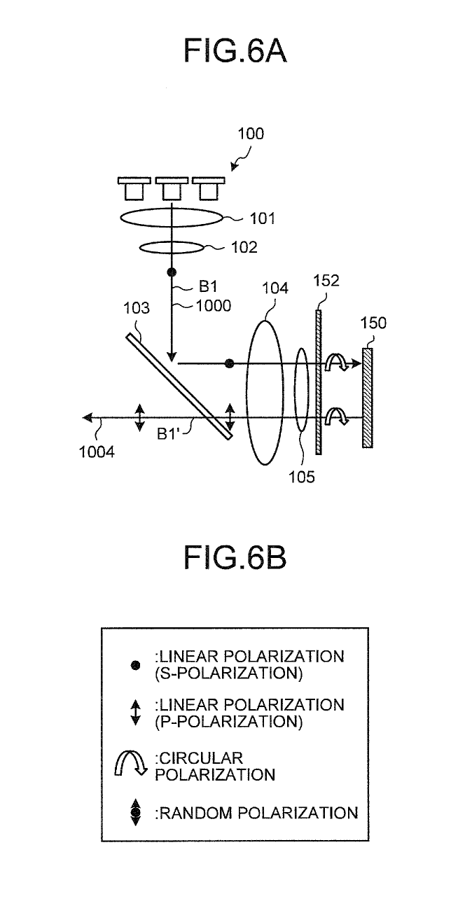

An optical path of the optical apparatus 2 according to the embodiment will be explained with reference to FIGS. 6A and 6B. In FIGS. 6A and 6B, elements common to aforementioned elements in FIG. 1 will be denoted with the same reference numeral and detailed explanations thereof will be omitted. As mentioned above, the quarter-wave plates 152 adhere closely to the surface of the phosphor wheel 150. However, for explanation purpose, each quarter-wave plate 152 is separated from the phosphor wheel 150 in FIG. 6A.

FIG. 6B illustrates introductory notes of symbols illustrated in FIG. 6A. In other words, a closed circle indicates linear polarization of the S-polarized light, an up-down arrow indicates linear polarization of the P-polarized light, an arcuate arrow indicates circular polarization, and a symbol of a closed circle with an up-down arrow indicates random polarization.

In FIG. 6A, the S-polarized B1-light emitted from the optical source 100 enters the dichroic mirror 103 through the condenser 101 and the collimator lens 102 in accordance with an optical path 1000. The dichroic mirror 103 reflects the incident B1-light in accordance with the characteristic illustrated in FIG. 2B. As the B1-light reflected off the dichroic mirror 103, the optical path thereof is changed. Then, the B1-light enters the phosphor wheel 150 through the condensers 104 and 105.

Herein, in a case where each quarter-wave plate 152 reaches the incident position of the B1-light upon the phosphor wheel 150, the B1-light enters each quarter-wave plate 152.

In a case where each quarter-wave plate 152 is disposed so that the direction angle of the optical axis at the incident position is set to be 45 degrees with respect to the polarization plane of the incident light, each quarter-wave plate 152 performs as a transformation unit. The transformation unit alternatively transforms the circular polarization and the linear polarization of light which is to pass through each quarter-wave plate 152. Similarly, as the linearly polarized light passing through each quarter-wave plate 152 twice, a polarization direction of the linearly polarized light can be transformed between the P-polarization and the S-polarization.

As mentioned above, each quarter-wave plate 152 is provided so that the direction angle of the optical axis is set to be 45 degrees with respect to the polarization plane of the incident light at the incident position of the phosphor wheel 150. Therefore, in the example illustrated in FIG. 6A, the B1-light which has entered each quarter-wave plate 152 from the dichroic mirror 103 reaches the surface of the phosphor wheel 150, as the polarization thereof is transformed to the circular polarization by each quarter-wave plate 152. Then, the B1-light whose polarization is the circular polarization is reflected off the surface of the phosphor wheel 150 as retaining the circular polarization. Then, the B1-light enters each quarter-wave plate 152 again. As a result, this B1-light can pass through each quarter-wave plate 152 twice, and the polarization thereof is transformed from the circular polarization to the P-polarization. Then, the B1-light is emitted from each quarter-wave plate 152 as B1′-light.

The P-polarized B1′-light emitted from each quarter-wave plate 152 enters the condenser 105 and 104 through the dichroic mirror 103. The dichroic mirror 103 transmits the incident B1′-light in accordance with the characteristic illustrated in FIG. 2B. The B1′-light is emitted from the dichroic mirror 103 in accordance with an optical path 1004 and enters a lens 106 illustrated in FIG. 1.

Note that in a case where each phosphor surface 151 reaches the incident position of the B1-light upon the phosphor wheel 150, the B1-light enters the phosphor surface 151, stimulates the phosphor, and radiates the P-light. This Y-light is emitted from each phosphor surface 151 and enters the dichroic mirror 103. The Y-light is transmitted through the dichroic mirror 103 and enters the lens 106 illustrated in FIG. 1. Furthermore, the Y-light is diffused upon the phosphor surface 151 and is emitted therefrom. Therefore, a part of the Y-light which passes through an exterior of the dichroic mirror 103 also enters the lens 106.

In addition, among the B1-light incident upon the phosphor surfaces 151, the B1-light which does not contribute to stimulating the phosphor is diffused upon the phosphor surfaces 151 to put the polarization thereof into disorder. Then, the B1-light is emitted from the phosphor surfaces 151 as B2-light, which is leakage light. With regard to the B2-light emitted from the phosphor surfaces 151, a part thereof is transmitted through the dichroic mirror 103, and another part thereof passes through the exterior of the dichroic mirror 103 and enters the lens 106. Accordingly, making the size of the dichroic mirror 103 small enough to reflect a luminous flux of the B1-light from the optical source 100, it is possible to improve usage efficiency of light.

The Y-light, B1′-light, and B2-light incident upon the lens 106 enter the mirror 111 as the Y-light and B-light (see FIG. 1).

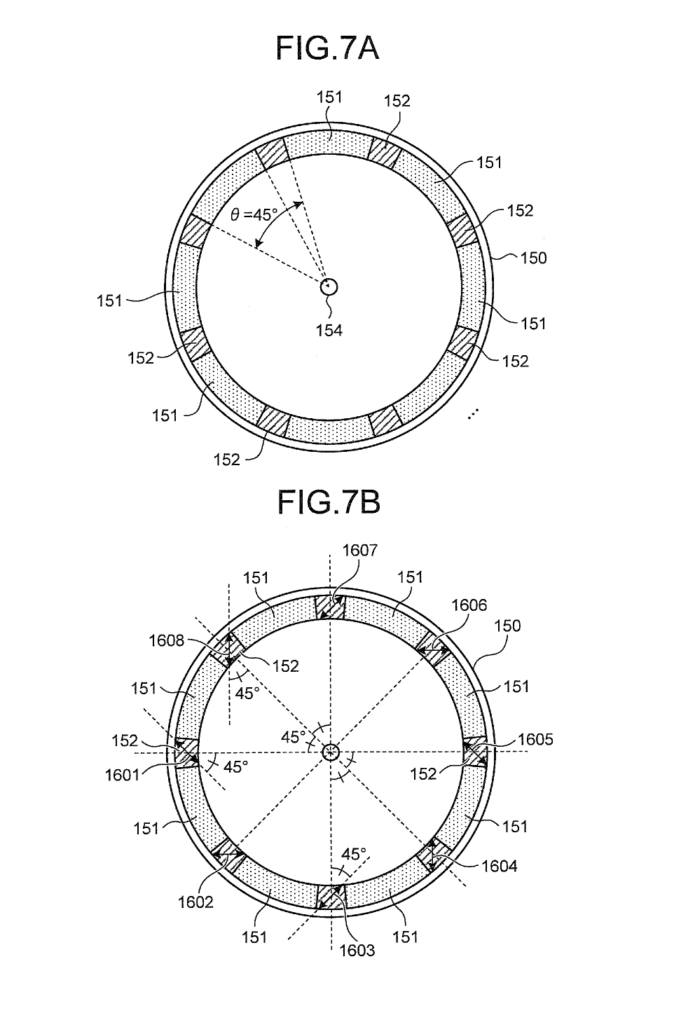

Next, more specific exemplary configurations of the phosphor wheel 150 according to the embodiment will be described with reference to FIGS. 7A and 7B. In the embodiment, there are provided the phosphor surfaces 151 which radiate the Y-light with respect to the phosphor wheel 150 and the quarter-wave plates 152 which emit the B1-light as changing the polarization thereof. The B1-light emitted from the quarter-wave plates 152 irradiates the optical modulator 119 together with the B2-light which is the leakage light. Furthermore, the Y-light radiated by the phosphor surfaces 151 is separated to the G-light and R-light by the color component separator 122 (see FIG. 1) and irradiates the optical modulators 125 and 128 respectively.

Therefore, in order to irradiate each optical modulator, 128, 125 and 119 by the light of each color, R, G, and B with appropriate light quantity balance, it is necessary to appropriately set a magnitude ratio of each phosphor surface 151 and quarter-wave plate 152. In this case, the magnitude of each phosphor surface 151 and quarter-wave plate 152 is a length in the circumferential direction where the incident position of the B1-light is set to be a radius with respect to the rotating axis 154.

The magnitude ratio of each phosphor surface 151 and quarter-wave plate 152 depends on characteristics of the phosphor included in each phosphor surface 151, characteristics of the dichroic mirror 103, disposition of each optical part in the optical apparatus 2, and the like. Therefore, the ratio can be solved experimentally for example. The magnitude ratio of each phosphor surface 151 and the quarter-wave plate 152 is considered to be substantially eight to two, for example, as illustrated in FIGS. 7A and 7B. In this case, the phosphor surfaces 151 account for 80% of the whole circumference where the incident position of the B1-light is set to be the radius with respect to the rotating axis 154, and the quarter-wave plates 152 account for the remaining 20%. Note that in FIGS. 7A and FIG. 7B, the quarter-wave plates 152 are emphasized for explanation purpose.

By the way, according to the configuration of the phosphor wheel 150 of the embodiment, the phosphor surfaces 151 and the quarter-wave plates 152 are alternatively and repeatedly disposed. Therefore, the optical apparatus 2 alternatively emits (alternatively blinks) the B-light and the Y-light (R-light+G-light). In this case, a so-called color break may occur in a projection image.

In other words, in a case where the optical modulators 128, 125, 119 for each color, R, G, and B are used and where the light of each color, R, G, and B successively irradiates the optical modulators 125, 128, 119 as the projection apparatus 1 according to the embodiment, when a display moves violently due to an image data or an observer, afterimages of R-color, G-color, and B-color detected by the observer do not overlap properly and are slipped off from each other. Such a phenomenon is called the color break.

An exemplary method for restraining the color break from being detected is a method where the light of each color, R, G, and B is switched with a high-speed. In the configuration of the optical apparatus 2 of the embodiment, a rotation speed of the phosphor wheel 150 is made faster.

The rotation speed of the phosphor wheel 150 which is possible to restrain the color break from being detected will be described with reference to FIG. 7A. As illustrated in FIG. 7A, with regard to a combination of one phosphor surface 151 and one quarter-wave plate 152 which are mutually adjacent, an angle θ of a circumference centering on the rotating axis 154 satisfies θ=45 degrees. In a case where the rotation speed of the phosphor wheel 150 is R (rpm: rotation per minute), frequency f (Hz) when the B-light and the Y-light blink is represented by the following Formula (1).

f=(R/60)×(360/9) (1)

In generally, the color break is less detectable when the frequency of the blink of each color, R, G, and B is of 180 Hz or more. Accordingly, based on the Formula (1), the angle θ and the rotation speed R preferably satisfy the following Formula (2).

f=(R/60)×(360/0)≧180 (2)

In the example illustrated in FIG. 7A, the angle θ=45 degrees. Therefore, when the rotation speed R of the phosphor wheel 150 is 1350 rpm or more, it is possible to restrain the color break from being detected.

Next, disposition of each quarter-wave plate 152 will be described with reference to FIG. 7B. As mentioned above, when the phosphor wheel 150 is rotated and each quarter-wave plate 152 reaches the incident position of the B1-light, each quarter-wave plate 152 is disposed so that the direction angle of the optical axis is set to be predetermined angle with respect to the polarization plane of the incident light. In FIG. 7B, a position corresponding to one quarter-wave plate 152 disposed in the left end of a diameter in a horizontal direction of the phosphor wheel 150 is considered to be the incident position of the B1-light. Furthermore, the polarization plane of the B1-light which is to enter is vertical to the incident position.

In this case, a direction angle of an optical axis 1601 of the quarter-wave plate 152 with respect to the polarization plane of the B1-light which is to enter is set to be 45 degrees. This is equivalent to setting a direction angle with respect to a radial direction of the optical axis 1601 to be 45 degrees as illustrated in FIG. 7B. By setting the angle of the optical axis 1601 in this manner, the S-polarized B1-light incident upon the quarter-wave plate 152 is reflected off the surface of the phosphor wheel 150. Therefore, the S-polarized B1-light passes through the quarter-wave plate 152 twice and is modulated to the P-polarized B1′-light.

Other quarter-wave plates 152 provided to the phosphor wheel 150 are similarly provided so as to set each direction angle to be 45 degrees with respect to a radial direction of each optical axis from 1602 to 1608. In such a manner, each direction angle with respect to the radial direction of each optical axis from 1601 to 1608 of each quarter-wave plate 152 is set to be 45 degrees in the embodiment. Accordingly, with regard to each quarter-wave plate 152 which reaches the incident position of the B1-light due to rotation of the phosphor wheel 150, each direction angle of the optical axis with respect to the polarization plane of the incident B1-light is controlled to be 45 degrees.

As explained above, in the optical apparatus 2 according to the embodiment, the rotatable phosphor wheel 150 having the mirror-like surface is divided to first and second regions in the circumferential direction. Herein, the phosphor surfaces 151 are provided to the first regions, while the quarter-wave plates 152 are provided to the second regions. Therefore, in a case where the phosphor wheel 150 is irradiated by the blue laser beam, the blue light and yellow light are alternatively emitted from the phosphor wheel 150, which improves efficiency of the blue light.

Herein, what is illustrated is the example where the phosphor surfaces 151 are solely formed in the regions A (first regions) of the embodiment. However, it should be noted that in the regions A, quarter-wave plates similar to the quarter-wave plates 152 disposed in the regions B may be disposed between the phosphor surfaces 151 and the mirror surface of the phosphor wheel 150. Due to such a configuration, the blue light which is emitted from the regions A instead of being used for stimulating upon the phosphor surface 151 of the regions A can also be an optical path where an effect similar to the regions B can be obtained. Therefore, it is possible to use the blue light more efficiently.

According to an embodiment of the present invention, it is possible to provide a higher efficient illumination optical source.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical apparatus comprising:
a reflective substrate which reflects irradiating light;
a driving unit which rotates the reflective substrate centering on a rotating axis; and
a phosphor provided to a first region which is one of first and second regions dividing the reflective substrate in a circumferential direction centering on the rotating axis.

2. The optical apparatus according to claim 1, wherein the first region and the second region are alternately provided in the circumferential direction of the reflective substrate.

3. The optical apparatus according to claim 1, further comprising:
a light selecting unit which reflects light in a first polarization direction of a first wavelength band and transmits light in a second polarization direction different from the first polarization direction of the first wavelength band and light of a second wavelength band longer than the first wavelength band; and
a transformation unit which is provided to the second region and alternatively transforms linear polarization and circular polarization,
wherein the light selecting unit is disposed so as to reflect the light in the first polarization direction from an optical source and to make the light irradiating the reflective substrate.

4. The optical apparatus according to claim 3, wherein the transformation unit is provided to the second region at an angle where the circular polarization is transformed to the second polarization direction at a position irradiated by the light from the optical source.

5. A projection apparatus, comprising:
the optical apparatus according to claim 1;
an optical modulator which modulates the light reflected off the reflective substrate and emitted from the optical apparatus in accordance with an image signal; and
a projection optical unit which emits the light modulated by the optical modulator.
